(19) United States
(12) Patent Application Publication
(10) Pub. No.: US 2009/0083111 A1
(43) Pub. Date: Mar. 26, 2009

(54) Systems and Methods for Coordinating Transportation Between Riders and Volunteer Drivers

(76) Inventor: Bob Carr, Atlanta, GA (US)

Correspondence Address: JOHN S. PRATT, ESQ;KILPATRICK STOCKTON, LLP, 1100 PEACHTREE STREET, ATLANTA, GA, 30309, US

(21) Appl. No.: 11/859,519

(22) Filed: Sep. 21, 2007

(51) Int. Cl. G06F 9/50

(52) U.S. Cl. 705/9

(57) ABSTRACT

A method for facilitating the matching of riders and volunteer drivers where a transportation request is communicated by or on behalf of one or more riders to one or more potential volunteer drivers who are selected from a pool of potential volunteer drivers, and where the selected potential volunteer drivers may either accept or decline the transportation request.

### FIELD OF THE INVENTION

The invention relates generally to systems and methods for facilitating the transportation of riders by volunteer drivers.

### BACKGROUND

There is a need to provide a dependable and flexible system of transportation for individuals, such as senior citizens, who are either unwilling or unable to operate a motor vehicle. Such transportation should be very low cost or free and should allow riders to maintain freedom and independence. Existing methods for providing transportation to individuals such as senior citizens are known, but none provide the benefits of the current invention.

For example, many existing systems use professional drivers to reliably provide transportation to senior citizens. Other systems rely on volunteer drivers, but require a commitment from the volunteers to certain routine schedules in order to ensure the riders' needs can consistently be met. There are drawbacks to such systems.

For example, systems employing professional drivers are more expensive to operate than systems using only volunteer drivers. Systems requiring routine commitments from volunteer drivers may dissuade people who would otherwise like to volunteer but who cannot make a regular commitment to such a program. A system is needed that will conveniently and reliably provide transportation to individuals using volunteer drivers, but that does not require the volunteers to commit to being available at regular or predetermined schedules.

### SUMMARY OF THE INVENTION

Embodiments of this invention relate to systems and methods for providing transportation to individuals using a pool of potential volunteer drivers to meet a rider's transportation needs. According to one embodiment, a rider seeking transportation submits a transportation request, which is evaluated against stored data relating to the pool of potential volunteer drivers. The request is used to define a transportation opportunity. The transportation opportunity can be communicated to a subset of the potential volunteer drivers who can accept or decline the opportunity. Acceptance of the transportation opportunity by a driver can result in the generation of a verification code, which is communicated to both the rider(s) and the driver. This verification code may be used by each party as a means of identifying the other party prior to the transportation event.

### FIGURES

FIG. 1 illustrates a system that can be used to implement various embodiments of the present invention.

FIG. 2 is a flowchart illustrating a method for facilitating the transportation of a rider by a volunteer driver.

### DETAILED DESCRIPTION

### System Overview

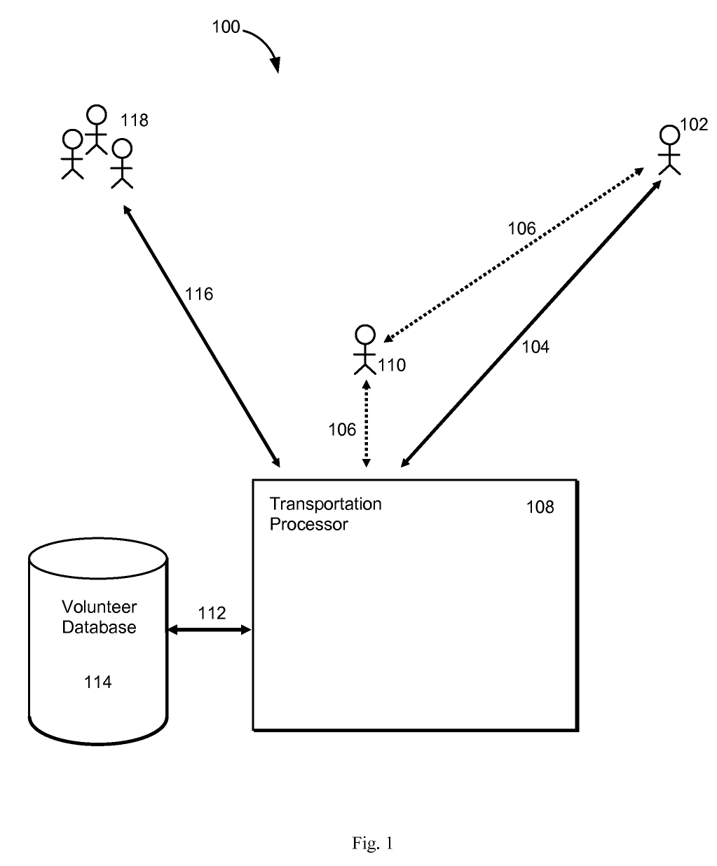

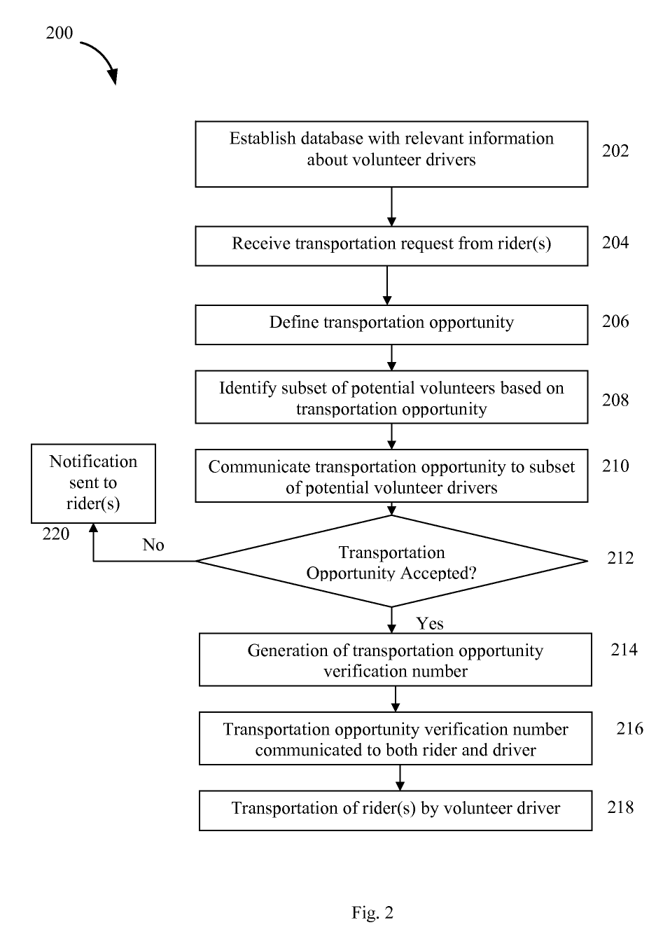

Various systems in accordance with the present invention may be constructed. FIG. 1 shows an illustrative system in which certain embodiments of the present invention, including those disclosed in FIG. 2, may operate. Embodiments of the present invention may operate in other systems, as well.

The system 100 shown in FIG. 1 comprises a rider 102 representing, for example, a senior citizen or other person seeking transportation. The rider 102 communicates via telecommunication link 104 with a transportation processor 108. Also shown in FIG. 1 is an optional telecommunication link 106 with an operator 110. According to certain embodiments, the rider may communicate with an operator 110 who acts as an intermediary between the transportation processor 108 and the rider 102. In other embodiments, the rider may communicate directly with the transportation processor 108. Communication with the transportation processor 108 can be over a telephone equipped with touch-tone input or voice recognition, through a web-based application, or via other suitable telecommunication means as may be known on the art.

The transportation processor 108 receives transportation request information from the rider 102 either directly or through an operator 110 and generates transportation opportunities from the requests. The transportation processor may comprise a computer processing unit programmed to carry out the methods described herein. Alternatively, the transportation processor may include other suitable electronic or paper-based systems for managing a database of potential volunteers and riders according to the methods described herein. The transportation request information may contain such information as a desired destination, desired pick-up time, duration of stay at desired location, round trip information, special needs, pick-up location, and other relevant information needed to define the transportation needs of the rider 102. The transportation processor is in communication with a potential volunteer in database 114 via link 112 which it can use to identify one or more potential volunteers. The transportation processor may assign one or more “best fits” by matching one or more potential volunteers to rider and/or transportation opportunity information. According to certain embodiments, the best fits can be based on criteria set by the rider and/or driver. The transportation processor is further capable of communicating via telecommunication link 116 with a group of potential volunteers 118 identified from the potential volunteer database 114. The potential volunteers 118 may represent a subset of a universe of potential volunteers stored on the potential volunteer database 114.

The potential volunteers 118 may receive the request via telecommunication 116, which can include, for example, email, telephone, pager, instant message, text message, or other suitable telecommunication means. One or more of the potential volunteers 118 can then communicate back to the transportation processor 108 via suitable telecommunication means also represented by telecommunication link 116 to indicate an acceptance of the transportation opportunity. The transportation processor can then generate a confirmation of the now accepted transportation opportunity to the rider 102 and to the potential volunteer within the potential volunteers group 118 who accepted the opportunity and may assign a confirmation ID. Methods that may be carried out according to certain embodiments are provided below in connection with FIG. 2.

### Example Methods

FIG. 2 illustrates an embodiment of a sample method 200 of matching a rider with a potential volunteer driver selected from a pool of potential volunteer drivers. Information about the rider in a database may be compared with information about potential volunteer drivers stored in the same or another database to match the rider with one or more potential volunteer drivers.

According to the method 200 illustrated in FIG. 2, a pool of potential volunteer drivers is established in block 202. Information concerning each of the potential volunteer drivers is maintained in a potential volunteer database 114 such that it may be communicated 112 to the transportation processor 108. In one example, such information could be maintained in an electronic database. The maintained information could include things such as personal ID information, vehicle information, feedback information, preferred trip time information, preferred trip location information, preferred rider information, typical route information, contact method information, current availability information, current location information, or other suitable information about potential volunteer drivers. A profile can be built tracking the volunteer driver and rider preferences and performance. According to certain embodiments, the profile can be a dynamic profile which can reflect the current availability of a potential volunteer. For example, the dynamic profile could be updated based on a current location of a potential driver or current availability of a potential driver. This can accommodate drivers who want to indicate temporary unavailability or who want to indicate an availability based on contingent information such as a current location or work/vacation schedule. The current location can be based, for example, on a cell phone cell location or triangulation or on a GPS signal from the potential volunteer, or other suitable method. Availability information can be based, for example, on a predefined schedule or on an ad hoc scheduling basis.

Personal information can include, for example, such information as the driver's age, gender, past or frequent destinations, preferences, etc. Vehicle information can include information describing the driver's vehicle accommodations, such as the number of doors, whether it is able to accommodate a wheel chair, whether it requires a step up entry, the amount of available storage space, etc. Feedback information can include information from riders rating a driver's performance, punctuality, general courtesy, etc. Preferred trip time information can include information identifying when a volunteer prefers to receive notification or transportation opportunities or when a potential volunteer is more likely to be able to provide volunteer services while traveling with the desired rider. For example, if a volunteer driver typically travels to shop from 10:00 a.m. to 11:30 a.m. in an area contiguous with the rider, then transportation opportunities coinciding with this commute time may be preferred by the volunteer rider. Preferred trip location information can identify locations or routes along which a driver can most confidently provide transportation. For example, if a driver typically travels from home to a school or marketplace during a morning commute, transportation opportunities for riders along a contiguous route will be more convenient for the driver to service.

Similarly, typical route information can identify typical routes of a volunteer driver. Contact method information can indicate how a driver prefers to be contacted and corresponding contact information such as telephone number, cell phone number, text, or email address. Preferred rider information can indicate a rider or sub-group of riders the preferred by or exclusively preferred by the driver. For example, a driver can indicate a willingness only to provide rides to riders from a common church group or common civic organization. Moreover, the personal information for a rider can indicate a sponsorship, destination preference, or exclusive destination preference. For example, a driver can be sponsored by a local commercial establishment and can indicate a preference or exclusive preference to provide rides only to that establishment.

In block 204 of the method 200, a rider 102 (or group of riders) seeking transportation communicates transportation request information to the transportation processor 108. For example, according to certain embodiments, a rider may place a telephone call to operator 110 and tell the operator 110 the rider's desired destination, when the rider would like to arrive at the destination, and an estimated length of stay at the desired destination. A rider may request more than one ride on a given call or may establish a standing request for a ride at recurring intervals, such as every Wednesday at 10:30 to the grocery store. However, the system may be configured to require the rider to make a request for each ride requested. According to certain embodiments, the rider may be a person-in-need requiring special care from a potential driver. In such embodiments, the needed volunteer-activity can be indicated, which can identify to a potential volunteer the type of assistance the person-in-need requires.

In block 206, the transportation processor 108 defines a transportation opportunity from the transportation request information. The transportation opportunity includes the necessary information extracted from the request, and will typically include at least a pick-up location, destination, and trip time. The transportation opportunity is then evaluated against the information in the potential volunteer driver database in block 208. For example, volunteers who have indicated a preference for trip times during which the requested trip time falls can be identified as a subset of the overall pool of volunteers, and the opportunity will be sent only to the subset. For example, a subset of four people may be identified from a pool of 20 volunteer riders based on trip time preferences of each. A selection of a subset of potential drivers may involve additional or external information. For example, the system may recognize that a destination is near a church and select a subset of potential drivers using information from the church. Potential drivers may also indicate that they are not available, for example when on vacation of on a particular day of the week, and will not be considered for a transportation opportunity during their unavailable time.

By evaluating the transportation opportunity against information in the database the subset of potential volunteers who receive the opportunity are more likely to accept it. In addition, by extending the opportunity to only a subset of the pool of potential volunteers, the system can prevent volunteers from receiving too many requests, which can also increase the likelihood that the contacted volunteers will in fact accept the opportunity.

In block 212, the potential volunteers may optionally accept or deny the transportation opportunity. Being free to accept or deny the opportunity encourages drivers who may not want to undertake a firm commitment to be included in the database and to be able to respond to requests that are convenient for them. This greatly expands the pool of potential volunteers willing to participate in such a system. Once a potential volunteer accepts the transportation opportunity, this information is communicated to the transportation processor. In the event that a transportation opportunity is not accepted by any potential volunteer, the rider can be informed that the request cannot be filled at that time. This may or may not be an iterative process such that if each driver in the first subset turns down the opportunity a new subset is selected. The system may ask one or more potential drivers at a single time.

When the opportunity is accepted, the transportation processor creates a unique verification code in block 214. This transportation opportunity verification code may be any combination of letters, numbers, or symbols and is used for security purposes to allow the rider to positively identify the driver and vice versa. The transportation opportunity verification code is communicated to the rider(s) and the volunteer drivers in block 216.

Finally, in block 218, the driver drives to the pickup location at the appointed time and presents the verification code along with other credentials such as a placard displaying a logo or other indicia of affiliation with the volunteer service. The rider can then recognize and verify that the driver is the person appointed by the system and accept the offer of transportation.

An embodiment of the invention also involves generating and using statistics about volunteers, riders, accidents, injuries and/or transportation opportunities. The present invention may also be applied to other volunteer activities such as home repair, security, medical care, and counseling, among others.

The foregoing description has been presented only for the purpose of illustration and description and is not intended to be exhaustive or to limit the invention to the precise forms disclosed. Numerous modifications and adaptations thereof will be apparent to those skilled in the art without departing from the spirit and scope of the present invention.

That which is claimed:

1. A method for coordinating transportation, comprising:
maintaining a database of driver information for a pool of potential drivers, wherein the potential drivers are volunteer drivers who have volunteered to provide rides without monetary compensation;
receiving a transportation rider request, the request associated with a rider transportation opportunity that requests a driver to transport a rider;
determining a subset of one or more drivers of the pool of potential drivers based at least in part on the potential driver information and the transportation rider request;
communicating to each of the subset of one or more drivers the transportation opportunity such that each driver in the subset may optionally accept or deny the transportation opportunity;
receiving an acceptance of the transportation opportunity from an accepting driver of the subset of one or more drivers; and
confirming the transportation arrangement by notifying the rider and the accepting driver.

2. The method of claim 1 further comprising generating a unique transportation opportunity verification code.

3. The method of claim 2 further comprising communicating the transportation opportunity verification code to the rider.

4. The method of claim 2 further comprising communicating the transportation opportunity verification code to the accepting driver.

5. The method of claim 1, wherein the transportation request is made by the rider.

6. The method of claim 1 further comprising tracking transportation segments.

7. The method of claim 1 further comprising confirming completion of the transportation opportunity.

8. The method of claim 1, wherein the potential driver information includes one or more of personal ID information, vehicle information, preferred trip time information, preferred trip location information, preferred rider information, typical route information, contact method information, current availability information, current location information, or sponsorship information.

9. The method of claim 1, wherein the potential driver information includes sponsorship information indicating an exclusive destination for the driver.

10. The method of claim 1, wherein the potential driver information comprises a dynamic profile reflecting current availability of the driver.

11. The method of claim 10, wherein the dynamic profile reflects a current position of the driver.

12. The method of claim 10, wherein the dynamic profile is based on a schedule for the driver.

13. A method for coordinating transportation, comprising:
receiving a transportation request, the request associated with a transportation opportunity that requests a driver to transport a rider;
requesting one or more drivers to accept or decline the transportation opportunity;
receiving an acceptance of the transportation opportunity from an accepting driver;
confirming the transportation arrangement by notifying the rider and the accepting driver;
generating a unique transportation opportunity verification code; and
communicating the transportation opportunity verification code to the rider and accepting driver.

14. A method for coordinating transportation between at least one rider and a volunteer driver, comprising:
determining a pool of potential volunteer drivers;
maintaining a database of potential volunteer driver information;
receiving a transportation request from a rider;
defining a transportation opportunity based on the transportation request;
determining a subset of the pool of potential volunteer drivers based at least in part on the potential volunteer driver information;
communicating the transportation opportunity to the subset of potential volunteer drivers who may optionally accept or decline the transportation opportunity;
receiving an acceptance of the transportation opportunity from a member of the subset of potential volunteer drivers;
generating a unique transportation opportunity verification code;
communicating the transportation opportunity verification code separately to the rider and the member of the subset of potential volunteer drivers.

15. The method of claim 14, wherein information about the pool of potential drivers includes one or more of a driver's driving record, age, gender, vehicle make and model, current location, preferences regarding travel to particular destinations, or preferences regarding particular times and dates of travel.

16. The method of claim 14, wherein the request information includes one or more of time of day during which travel is desired, a desired pick-up and drop-off location, a needed wait time prior to a return trip, or special vehicle needs.

17. The method of claim 14 wherein the communication link between the one or more of the plurality of drivers and the one or more passengers is via one or more of telephone, text messaging, Internet, e-mail, instant messaging, or pager.

18. A method for coordinating a volunteer activity, comprising:
maintaining a database of volunteer information for a pool of potential volunteers;
receiving a volunteer-activity request from a person-in-need, the request associated with a volunteer opportunity that requests a volunteer to assist the person-in-need;
determining a subset of one or more potential volunteers within the pool of volunteers based at least in part on the volunteer information and the volunteer-activity request;
requesting each of the subset of one or more volunteers to accept or decline the volunteer opportunity;
receiving an acceptance of the transportation opportunity from an accepting volunteer of the subset of one or more volunteers; and
confirming the volunteer arrangement by notifying the person-in-need and the accepting volunteer.

19. The method of claim 18 further comprising generating a unique volunteer opportunity verification code.

20. The method of claim 18 further comprising communicating the volunteer opportunity verification code to the person-in-need.

21. The method of claim 18 further comprising communicating the volunteer opportunity verification code to the accepting volunteer.

22. The method of claim 18, wherein the volunteer-activity request is made by the person-in-need.
